(19) United States
(12) Patent Application Publication
(10) Pub. No.: US 2012/0084090 A1
(43) Pub. Date: Apr. 5, 2012

(54) EPROCUREMENT CHANGE REQUEST PROCESS

(75) Inventors: Bridget Woodard, Oakland, CA (US); Weishin Yin, Cupertino, CA (US); Jenny Kwan, Redwood City, CA (US); Hui Dong, Vancouver (CA); Rachel Ip, Castro Valley, CA (US); Earnest Ivie, Keller, TX (US)

(73) Assignee: Oracle International Corporation, Redwood Shores, CA (US)

(21) Appl. No.: 12/898,204

(22) Filed: Oct. 5, 2010

(51) Int. Cl. G06Q 30/00; G06Q 90/00

(52) U.S. Cl. 705/1.1; 705/500

(57) ABSTRACT

The present invention is directed to methods and systems for implementing a procurement change request process. The method includes receiving a request to edit a requisition order from a requestor. The requisition order has been previously completed and the requisition order includes a lines. The method further includes receiving updates to at least one of the lines, and based on the received updates, updating the at least one of the lines of the requisition order. Further, the method includes determining that the at least one of the lines has been sourced to a purchase order, in response to the at least one of the lines being sourced to the purchase order, creating a requisition change request for the at least one of the lines, and updating the purchase order with the updates to the at least one of the lines of the requisition order.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### BACKGROUND OF THE INVENTION

Changes to requisitions from a requester (or other party involved with the transaction) are a frequent occurrence. Presently, a requester is required to go back and edit the purchase order directly, in order to affect any changes to a requisition. The requisition cannot be changed and have the changes flow through automatically to affect the change orders. Further, none of these changes are captured within the requisition. This is a major issue for customers, since many requesters are not familiar with purchase orders, and for continuity purposes, the data needs to be changed at each step of the process.

For example, if a requester creates a requisition for one line with a quantity of 5. The line is sourced to a purchase order, the purchase order line-schedule references the requisition, and the purchase order is then dispatched. If the requester subsequently desires to change the quantity to 20, the current change request process may take the requester to a purchase order line schedule change page, and allow the requester to submit the change request. Once the change request is approved and processed, the purchase is updated and re-dispatched with a quantity of 20. However, the requisition still shows a quantity of 5. Further, on the purchase order the first quantity of 5 is referenced to the requisition; the additional quantity of 15 is not associated with the requisition. As such, core requisitions does support change requests, but it does not provide the ability to require or request reasons for the changes. Hence, improved rating and ranking methods and systems are needed in the art.

### SUMMARY OF THE INVENTION

According to one embodiment of the present invention, a method is described. The method includes receiving a request to edit a requisition order from a requestor. The requisition order has been previously completed and the requisition order includes a lines. The method further includes receiving updates to at least one of the lines, and based on the received updates, updating the at least one of the lines of the requisition order. Further, the method includes determining that the at least one of the lines has been sourced to a purchase order, in response to the at least one of the lines being sourced to the purchase order, creating a requisition change request for the at least one of the lines, and updating the purchase order with the updates to the at least one of the lines of the requisition order.

According to yet another embodiment, a method is described. The method includes receiving a request to edit a requisition order from a requestor. The requisition order has been previously completed and the requisition order includes a plurality of lines and a budget. The method further includes receiving updates to at least one of the plurality of lines of the requisition order, based on the received updates, updating the at least one of the plurality of lines of the requisition order, and determining that the at least one of the plurality of lines has been sourced to a purchase order. Further, the method includes in response to the at least one of the plurality of lines being sourced to the purchase order, creating a requisition change request for the at least one of the plurality of lines, based on the requisition change request, checking the budget to determine if the budget is valid and checking if the requisition change request generates a process exception for the requisition order, and in response to the budget being valid and no process exceptions being generated, updating the purchase order with the updates to the at least one of the plurality of lines of the requisition order.

According to another embodiment of the present invention, a computer-readable medium is described. The computer-readable medium includes instructions for receiving a request to edit a requisition order from a requestor. The requisition order has been previously completed and the requisition order includes a lines. The computer-readable medium further includes instructions for receiving updates to at least one of the lines, and based on the received updates, updating the at least one of the lines of the requisition order. Further, the computer-readable medium includes instruction for determining that the at least one of the lines has been sourced to a purchase order, in response to the at least one of the lines being sourced to the purchase order, creating a requisition change request for the at least one of the lines, and updating the purchase order with the updates to the at least one of the lines of the requisition order.

### BRIEF DESCRIPTION OF THE DRAWINGS

FIGS. 1A and 1B are simplified flow diagrams illustrating a method 100, according to an embodiment of the present invention.

FIG. 2 is a simplified block diagram illustrating a system 200, according to an embodiment of the present invention.

FIGS. 3A and 3B are user interfaces, according to an embodiment of the present invention.

FIGS. 4A and 4B are user interfaces, according to an embodiment of the present invention.

FIG. 5 is a user interface, according to an embodiment of the present invention.

FIGS. 6A-6D are user interfaces, according to an embodiment of the present invention.

FIGS. 7A-7E are user interfaces, according to an embodiment of the present invention.

FIG. 8 is a user interface, according to an embodiment of the present invention.

FIG. 9 is a simplified block diagram illustrating physical components of a system environment 900 that may be used in accordance with an embodiment of the present invention.

FIG. 10 is a simplified block diagram illustrating the physical components of a computer system 1000 that may be used in accordance with an embodiment of the present invention.

### DETAILED DESCRIPTION OF THE INVENTION

The present invention is directed to an eProcurement system with the ability to communicate a changed requirement through the procurement system in an easy and effective manner. In one embodiment, the present invention manages this requirement by providing an interface to change requisitions after they are sourced to purchase orders (which may have been dispatched to suppliers). Further, the present invention provides the ability to track the changes within the system and have these changes go through the appropriate approvals. For example, changes are allowed to be made to sourced requisitions that are initiated from eProcurement or sProcurement applications, and changes are also tracked. For eProcurement requisitions that have been sourced, change requests may be created. When the change requests are approved and purchase orders are updated, the requisitions are updated to reflect the changes.

Change tracking may be invoked on eProcurement requisitions in the same way that is done for core requisitions, using batch/sequence logic to track changes made. Each time a change is made to a requisition where tracking is used, a new change sequence may be created. When a requisition change control status is changed (i.e., Approved, Budget Checked, Sourced), a batch may be created.

In one embodiment, a change request feature of the present invention, makes it very configurable and intuitive for a user (or customer) to make changes to a requisition. These changes then flow seamlessly through the eProcurement process, with the appropriate approvals, and are kept synchronized among all transactions. For example, users are able to specify which requisition fields that would require re-approvals and can trigger change request to update associated purchase orders utilizing a change template. This flexibility gives different customers the ability to tailor the eProcurement system to meet approval requirements of individual companies. Further, users may be allowed to specify reasons for the change requests

Additionally, changes to the requisition are easy to make. For example, a user can go directly back to his/her original requisition to make any changes that are allowed, based on the business unit's change template setup. Then when changes are made to requisitions, those changes can be reviewed and approved or denied, following the appropriate requisition approval process. Also, buyers can automatically be notified when a change request comes in and after buyers' approval, these changes can be reflected on the associated purchase orders. Further, requesters can easily determine the status of their changes through a manage requisition page's lifespan presentation, or similar interface.

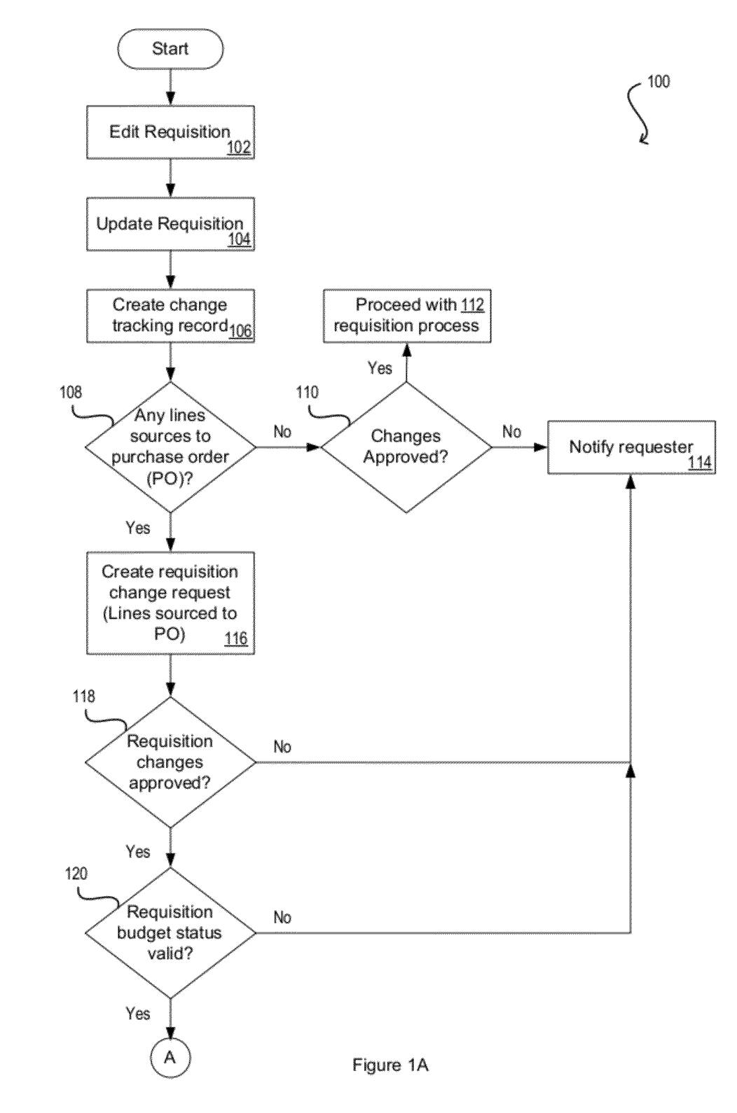

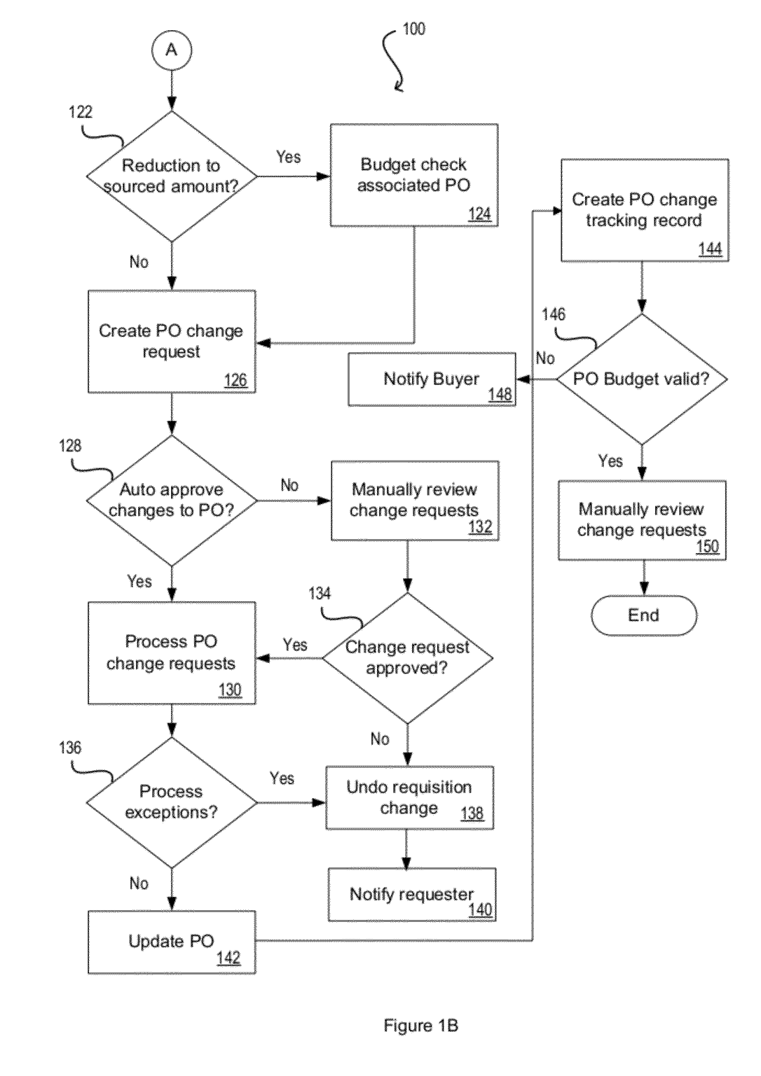

Turning now to FIG. 1A, which illustrates a method 100 for implementing a procurement change request process, in accordant with embodiments of the present invention. At process block 102, a user may begin to edit a requisition. In one embodiment, the requisition may have been previously completed, and the user subsequently desires to change at least one aspect (or line) of the requisition. Accordingly, the requisition will then be updated with the changes received from the user (process block 104), and a change tracking record will then be created (process block 106).

At decision block 108, a determination is made whether any lines from the requisition order have been sourced to a purchase order. If none of the lines from the requisition order have been sourced to the purchase order, then the change is “caught” early enough in the process, and a check to determine if the changes are approved can be made (decision block 110). If it is determined that the change is approved, then at process block 112, the requisition process continues. Otherwise, if the changes are not approved, then at process block 114, a message is sent to the requester notifying him/her that the change did not go though, and the requisition remains the same.

Returning to decision block 108, if it is determined that at least one of the lines have been sourced to a purchase order, then a process block 116, a requisition change request (i.e., for the lines sourced to the purchase order) is created (process block 116). The requisition change request will be described in more detail below. At decision block 118, a determination is made whether the requisition changes are approved. If the changes are not approved, then at process block 114, the requester is notified. However, if the requisition changes are approved, then at decision block 120, a determination is made whether the requisition's budget status is valid. If the requisition budget is determined to not be valid, the requestor is notified (process block 114).

If the requisition's budget status is valid, then method 100 continues to point ‘A’. At point “A”, FIG. 1B continues method 100. At decision block 122, a determination is made whether the requisition change reduces a sourced amount. For example, a requisition may be for 10 widgets, but the change to the requisition order may bring the number of widgets down to 5. A reduction in a sourced quantity can cause a change in the budgeted amount of the requisition order. Accordingly, if a reduction of the sourced quantity is determined, then at process block 124, a budget check of the associated purchase order is performed.

Alternatively, if no reduction to the sourced amount occurs, then at process block 126, a purchase order change request is created. In one embodiment, an auto-approve changes to the purchase order option is set (decision block 128), and therefore at process block 130, the change request for the purchase order is processed. Alternately, if the auto-approve changes to the purchase order option is not set, then at process block 132 a manual review of the changes to the purchase order occurs.

At decision block 134, if the change request is approved, then the changes to the purchase order are processed (process block 130); however, if the changes are not approved, then at process block 138, the changes to the requisition are undone (i.e., the changes revert back to the original values in the requisition). Then, at process block 140, the requester is notified that the changes to the requisition have been undone.

If the changes to the purchase order have been processed, then at decision block 136, a determination whether process exception have occurred is made. One example of a process exception may be that the goods have already been shipped or if an invoice for the purchase order has already been sent to the buyer. If process exceptions have occurred, then at process block 138, the changes to the requisition are undone and the requester is notified (process block 140). If there are no process exceptions, then at process block 142, the purchase order is updated to reflect the changes to the requisition order.

At process block 144, a purchase order change tracking record is created. Subsequently, in light of the changes to the purchase order, at decision block 146, a determination is made whether the purchase order's budget is valid. If it is determined that the purchase order's budget is not valid, then at process block 148, the buyer is notified that the purchase order's budget is invalid. If the purchase order's budget is determined to be valid, then at process block 150, a manual review of the change requests is performed.

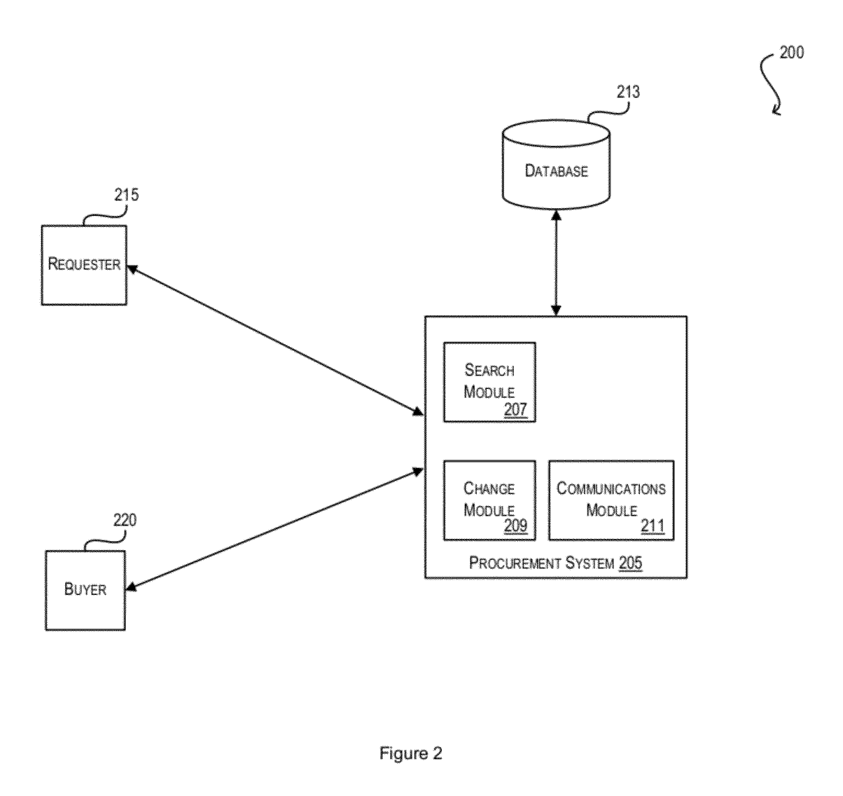

Turning next to FIG. 2, which illustrates a system 200 for implementing a procurement change request process as in method 100, in accordance with embodiments of the present invention. In one embodiment, system 200 may include a procurement system 205 which includes a search module 207, a change module 209, and a communications module 211. Furthermore, the procurement system 205 may be in communication with a database 213, a requester 215, and a buyer 220. Accordingly, the elements of system 200 may be configured to implement one or more of the steps described in FIGS. 1A and 1B.

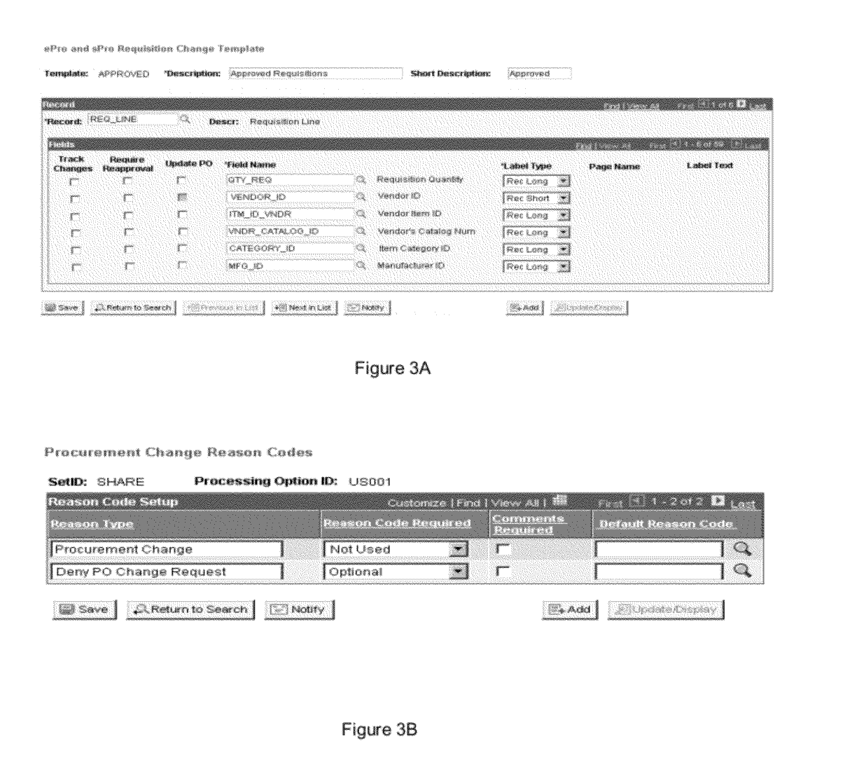

Referring now to FIG. 3A, which illustrates a user interface for generating a requisition change template, according to embodiments of the present invention. The user interface provides an interface for creating a new requisition change template page. This page may also be used by the core requisition system. Furthermore, this interface can be accessed from the eProcurement menu or the sProcurement menu or from a product related options in a setup menu.

This interface further displays fields which may be eligible for change tracking, and such fields will be editable on the requisition. Further, checkboxes for fields which are designated as ineligible for change tracking should be grayed out (or a similar designation). Table 1 shows one example of the fields that may be included in a requisition and/or purchase order. The Eligible to Update Purchase Order column indicates whether the field can be used to update purchase orders. If the field is not eligible to update purchase orders, the checkbox should be grayed out on the page.

TABLE 1

| | Eligible to |
|---|---|
| Trackable ePro/sPro Req Field | Update PO |
| Req Name | N |
| Requester | N |

| | |
|---|---|
| Use Pro Card/Card Number | N |
| Priority | N |

| | |
|---|---|
| Line Quantity | Y |
| Consolidate with other reqs | N |
| Override Suggested Vendor | N |
| Line Details | N |

Item Details

| | |
|---|---|
| Buyer | N |
| Vendor | N |
| Vendor Location | N |
| Vendor's Catalog | Y |
| Vendor Item ID | Y |
| Manufacturer | Y |
| Manufacturer Item ID | Y |
| Physical Nature | N |
| RFQ Required | N |
| Stockless Item | N |
| Amount Only | N |
| Inspection Required | N |
| Configuration Information | N |

| | |
|---|---|
| Sourcing Controls | N |

| | |
|---|---|
| Calculate Price | N |
| Inventory Source Flag | N |

| | |
|---|---|
| Quantity | Y |
| Due Date (Dock Date) | Y |

| | |
|---|---|
| Ship To/One Time Address | N |

| | |
|---|---|
| Attention | Y |
| Distribute by Quantity | N |
| Item by Description | |

| | |
|---|---|
| Item Description | Y |
| Price | Y |
| Unit of Measure | Y |
| Currency | N |
| Category | Y |

| | |
|---|---|
| Req Comments | N |
| SPro Status | N |
| SPro Service Provider | N |
| Scoped Out: Distribution Quantity | Y |
| Scoped Out: All Distribution/Asset Information | |

| | |
|---|---|
| Distribution Percent | Y |
| Entry Event | N |
| Account/GL Account Segments | Y |
| Projects Business Unit* | Y |
| Project/Activity/Source Type/ Category/ | Y |
| SubCat | |
| Inventory Business Unit -- Note: | Y |
| Changes to Inventory BU will be | |
| allowed after the order is sourced only if | |
| the change does not result in a change | |
| to the GL Business Unit | |
| Statistics Code | Y |
| Asset Management Business Unit | Y |
| Profile ID/CAP #/Tag | Y |
| Number/Sequence/Employee ID/Cost | |
| Type | |

In one embodiment, the “Scoped Out” field indicates that if any chart field segment is selected for tracking, all active chart field segments may also be selected. This is so the complete chart field can be viewed for approval and passed to purchase order. In a further embodiment, the template may have a checkbox (or the like) to indicate whether a change to a field will trigger re-approval of the requisition. This re-approval logic would be applied when approval workflows are used. Furthermore, changes to some fields may automatically trigger re-approval. These fields may automatically be checked on without the ability to be changed. These fields may include: REQ_LINE.QTY_REQ, REQ_LINE.PRICE_REQ, REQ_LINE_SHIP.QTY_REQ, and REQ_LINE_SHIP.PRICE_REQ. Whether or not re-approval is required when a quantity or price is decreased may be controlled by the requisition approval workflow settings.

In a further embodiment, if a requisition comment option is selected for tracking, only deletions of comments may be tracked with the status field available for tracking. Further, the re-approval and update purchase options may not be available.

In one embodiment, the Eligible to Update PO checkbox may indicates whether the field can be used to update purchase orders. If the field is not eligible to update purchase orders, the checkbox should be grayed out on the page (e.g., VENDOR_ID in FIG. 3A). Additionally, fields with a ‘Y’ in the Eligible to Update PO column indicates which fields should be available to select on the template (however, this indicate can be changed for each field).

Templates can be accessed from several places, for example, in add eProcurement requisition change templates to the purchasing options menu under eProcurement options setup, add to maintain eProcurement options menu under an administer procurement menu, or add access to eProcurement requisition change templates under sProcurement setup options.

Turning now to FIG. 3B, which illustrates a user interface for entering procurement change reason codes, in accordance with aspects of the present invention. The user interface provides a change reasons link which may be added on a purchasing processing options page (i.e., BUS_UNIT_OPT_PM) that may take users to a page where they can define how reason codes will be used in purchasing.

In one embodiment, the reason types may include a procurement change, a deny PO change request, or the like. New reason types can be added to support requisition change tracking. A reason code required drop-down box may include the following options: Not Used, Required, and Optional. Further, comments may be required in conjunction with entering a reason code, as such the comments required checkbox may be toggled. If comments are not required, the comments may are optional when a reason code is entered. Comments that are defined on the reason code setup page may default when the reason code is selected on a transaction. The defaulted comments may be used to satisfy the requirement when comments are mandatory. Furthermore, a default reason code may be established for each reason type. Also, contract changes may be included on a contract and vendor rebate controls page.

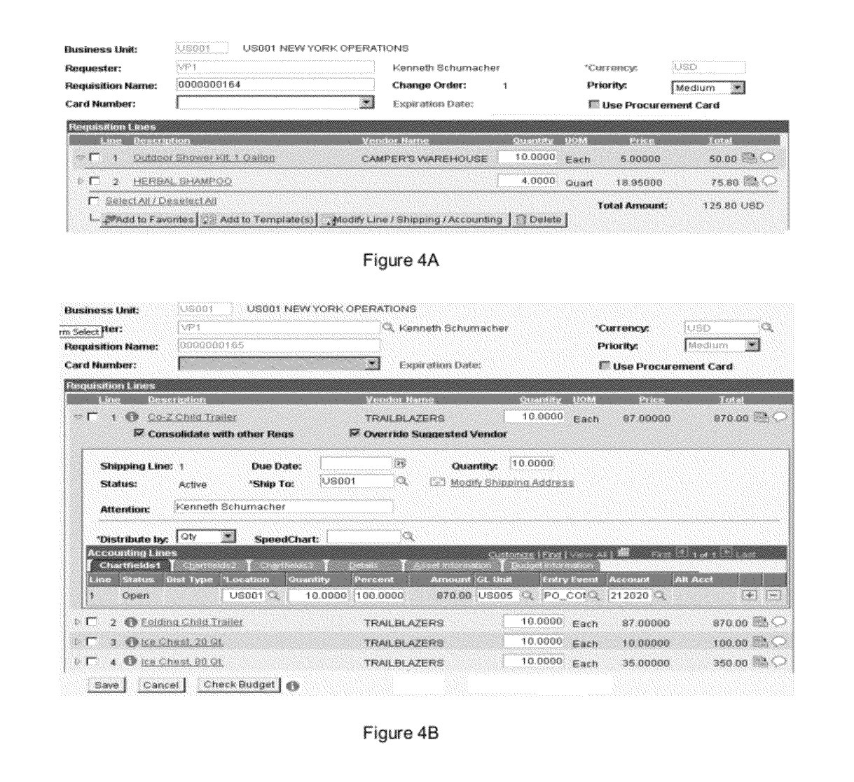

Turning now to FIGS. 4A and 4B, which illustrate user interfaces for changing requisitions when no requisition lines have been sourced, in accordance with aspects of the present invention. The user interface in FIG. 4A provides a role action to hide change order numbers (this may be used for novice users so that this role action is not displayed). When the page is saved, a window may pop up where users can enter a change reason and change comments. If reason code is required (see above), a change reason code will be entered. If it is optional, users can elect not to enter a change reason. The change order logic described should then be invoked and if changes were made to any tracked fields, records of the change will be written to REQ_CHNG tables.

FIG. 4B illustrates a user interface for changing requisitions when requisition lines have been sourced, in accordance with aspects of the present invention. The user interface provides users with the ability to edit any line has that been sourced (but not closed) as long as change requests are allowed for the dispatch status and supplier. Changes may be made and upon saving the user may see a message that a purchase order change request was created for those lines already sourced to purchase orders. An edit requisition page may allow users to update both lines that have been sourced and those that have not.

The user interface may include an icon indicating the status of sourcing. For example, a Sourced to PO icon and an unavailable for edit icon (lock icon). If the line has not yet been sourced, no icon should be displayed. There may be restrictions on whether a user can use “Edit Mode” and these lines would be unavailable for edit. Hover text for the icon would explain that a requisition line cannot be edited. For example. users may not be able to edit requisition lines when: Lines have been submitted for an RFQ, sourcing is in process for the requisition line, a sourcing event is in process for the line item, a line is sourced to inventory, or the line is a sProcurement requisition line that has been sourced.

Furthermore, various fields may be available for edit depending on the sourcing status. Table 2 below shows which fields may be editable when the requisition line is sourced and when the line is not sourced. The fields marked ‘Y’ in the Allow Change if Sourced column may only be editable if the Allow to Change PO option is selected for the field in the business unit options (nonetheless, these settings may be changed).

TABLE 2

| Editable ePro Req | Allow Change if | Allow Change |
|---|---|---|
| Field | Not Sourced | if Sourced |
| Quantity | Y | Y |
| Consolidate with | Y | N |
| other reqs | | |
| Override Suggested | Y | N |
| Vendor | | |
| Line Details | | |
| Item Details | | |

| | | |
|---|---|---|
| Buyer | Y | N |
| Vendor | Y | N |
| Vendor | Y | N |
| Location | | |
| Vendor's | Y | Y |
| Catalog | | |
| Vendor Item | Y | Y |
| ID | | |
| Manufacturer | Y | Y |
| Manufacturer | Y | Y |
| Item ID | | |
| Physical | Y | N |
| Nature | | |
| RFQ | Y | N |
| Required | | |
| Stockless | Y | N |
| Item | | |
| Amount Only | Y | N |
| Inspection | Y | N |
| Required | | |
| Configuration | Y | N |
| Information | | |

| | | |
|---|---|---|
| Contract ID | Y | N |
| Contract Line | Y | N |

Sourcing Controls

| | | |
|---|---|---|
| Calculate | Y | N |
| Price | | |
| Inventory | Y | N |
| Source Flag | | |

| | | |
|---|---|---|
| Due Date (Dock | Y | Y |
| Date) | | |
| Ship To/One Time | Y | Y |
| Address | | |
| Attention | Y | Y |
| Distribute by | N | N |
| Quantity | | |
| Speedchart | Y | N |
| Item by Description | | |
| Item Description | Y | Y |
| Price | Y | Y |
| Unit of Measure | Y | Y |
| Currency | Y | N |
| Category | Y | Y |
| Req Comments | Y | N |
| Reason Code | Y | Y |
| Scoped Out: | Y | Y |
| Distribution | | |
| Quantity | | |
| Scoped Out: | Y | Y |
| Distribution/Asset | | |
| Information | | |
| (Percent, Location, | | |
| Account, alt | | |
| Account, Operating | | |
| Unit, Fund, | | |
| Department, | | |
| Program, Class, | | |
| Budget Reference, | | |
| Program, Affiliate, | | |
| Fund Affiliate, | | |
| Operating Unit | | |
| Affiliate, Budget | | |
| Date, Statistics | | |
| Code, Inventory | | |
| Unit, PC Business | | |
| Unit, Project, | | |
| Activity, Source | | |
| Type, Category, | | |
| Subcategory, Asset | | |
| Management | | |
| Business Unit, | | |
| Profile ID, | | |
| Capitalized Flag, | | |
| Cost Type) | | |
| Scoped Out: Entry | Y | N |
| Event | | |

Additionally, if fields are not eligible for change, the field may be grayed out. In conjunction with requisition quantity increases, schedules may be added to the requisition line when allowed by, for example, the business unit option settings. Distribution lines may be added to the requisition line, and role action may need to be taken into consideration in conjunction with this requirement (e.g., Novice Requester cannot edit distributions). Further, there may be some restrictions that exist on changing requisitions. Users should receive a message explaining that they cannot change a requisition when one of the following conditions exist: users cannot change distributions on sourced requisition quantities (distribution information should be grayed out), users cannot cancel a requisition schedule if the schedule is associated to the only active schedule for a PO line, users cannot change a value where that field is tied to a PO change request that is pending buyer approval, or any other restrictions to allowable requisition changes.

In a further embodiment, if commitment control is being used, users cannot make a change to quantity or price that will reduce the amount of the requisition, if the purchase order to which it is associated does not have header budget status of “Valid.” Also, if a requisition is sourced to multiple purchase orders, changes to price may not be allowed.

If changes to reduce requisition quantity are made and allowed, then changes in requisition quantity to less than the quantity sourced can be made. In one embodiment, an exception may be when the changed line or schedule has been sourced to multiple purchase orders, then reductions to quantity may not be allowed. Users should receive a message indicating that because the requisition is sourced to multiple PO's, the PO change requests must be created in the purchasing interface.

Furthermore, if the line is an amount only line or is distributed by amount, re-pricing logic should not be invoked when a change is made to a field such as ship-to or due date. Further, lines and schedules may be eligible to be cancelled, regardless of whether the lines have been sourced. If the line or schedule is canceled and the requisition has been sourced, a change request should be created, and the change request can be created regardless of whether the PO has been dispatched. Additionally, existing limits to cancellation should be maintained (e.g., all schedules associated to a line cannot be cancelled, all distributions associated to a schedule cannot be cancelled, etc.).

In a further embodiment, if the changed line or schedule has been sourced to multiple purchase orders, and the change is an increase to requisition quantity, no change request will be created. Then, the requisition will be updated with the new quantity, a requisition change tracking records will be created, the new open quantity will be available for sourcing, and the requester will see a message that the requisition has been changed. For all other requisition changes, if the line has been sourced when the page is saved, then the requisition is changed and the requisition change logic is invoked to create requisition change tracking records, and requesters should receive a message that a PO change request(s) will be created upon approval and a valid budget status.

In a further embodiment, if they apply changes from all other sources is not toggled on, then the purchase order change request records will be written, with approved status set to N. Further, if the requisition change was to a field other than quantity and that requisition was sourced to more than one purchase order, multiple change requests should be created. A request should be created for the field on each PO to which the requisition was sourced. Also, a line should be written to the buyer's worklist to notify the buyer that a change request needs approval. If the line has been sourced, and the Apply Changes from all other sources is toggled on, and purchase order change request records will be written, with approved status set to ‘Y’.

If the requisition change was to a field other than quantity and that requisition was sourced to more than one purchase order, multiple change requests should be created. A request should be created for the field on each PO to which the requisition was sourced. Further, if commitment control is being used and the requisition change resulted in a decrease to the sourced amount, when the requisition is budget checked and the budget status is valid, the associated PO should be budget checked immediately to ensure the correct budget amount is available for spending. Then, for the purchase order(s) to which the requisition is sourced, the budget status for the header (BUDGET_HDR_STATUS and BUDGET_HDR_STS_NP) and budget status for the distribution line to which the requisition is associated (BUDGET_LINE_STATUS) should be set to ‘N’, and budget checking should then be invoked for the purchase order.

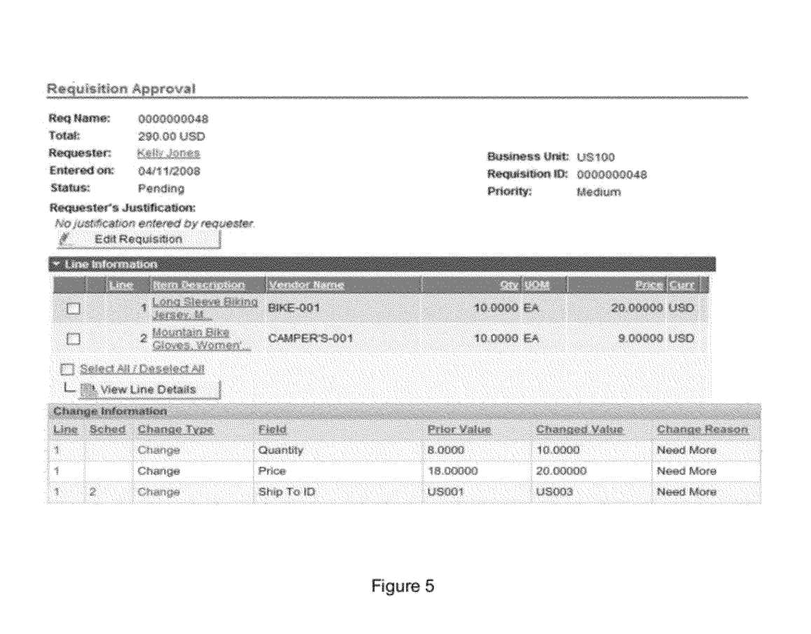

Turning next to FIG. 5, which illustrates a user interface for approving requisition change requests, in accordance with aspects of the present invention. The user interface provides approvers with changed requisitions for approval, and change information should be displayed on the approval page (PV_CHNG_REQ_APPR).

When notifying the buyer of PO change requests from requisitions, and manual approval of a requisition change request is needed, a notification may be sent to the buyer for the changed item. Buyers may then see change requests resulting from changes to requisitions on an approve change requests page. The buyer can approve or deny the change request, and if the request is denied, a message may be sent to the requester to inform the buyer of the denial. Further, a new worklist template may be created for the requisition change request, and when a requisition is approved and budget checked (i.e., BUDGET_STATUS=V or N), a user assigned to the buyer role should receive notification either through an e-mail or on a worklist (or other appropriate communications medium) that a purchase order change request has been created. Both the e-mail and the worklist may then link to the approve change requests interface in FIG. 5. Furthermore, the e-mail may include the REQUESTER_ID, Requester Phone Number, Requester e-mail ID, Requisition Business Unit, Requisition ID, Requisition Line, and PO ID.

In one embodiment, the worklist may include the following: from—REQUESTER_ID from the requisition, date from—requisition approval date, business unit, req ID, requisition line(s), requisition schedule, requisition distribution, requisition item, and PO ID. The link should include the business unit, PO ID, requisition ID, and requisition line(s) so that the worklist user can be taken to the approve change requests interface where the user can see the information provided on the requisition that pertains to the new item.

Additionally, when the worklist link is selected, the user may be taken to a change order lookup page (CHNG_ORD_LOOKUP) with the grid filtered to display the PO(s) associated to the changed requisition. Alternatively, if the change order lookup page is accessed from the buyer center menu, the page should be populated with the user's default business unit and change order source equal to the change request. This page can also be accessed from the approve change requests page (CHNG_RQST_SELECT).

On the change request selection page (CHNG_RQST_SELECT) (and the change request details page (CHANGE_REQUEST)) a selection option, requisition ID From/To, should be displayed when the change order source (change request) is selected. The change order request page (CHNG_ORD_LOOKUP) should include a drop down selection of approved or denied (buyers may need to explicitly deny change requests).

A requisition information tab may be included in the change request details page (CHANGE_REQUEST). The tab page should show the requisition number, schedule, and requester. Requester name should be shown as, for example, a hyperlink that can provide buyer with contact information for the requester. Further, a change reason tab should be included in the change order request page (CHNG_RQST_LOOKUP). The tab page should include the reason code and comments. Also, if a change request has been accepted, but is not yet processed, the deny change option is available to the buyer.

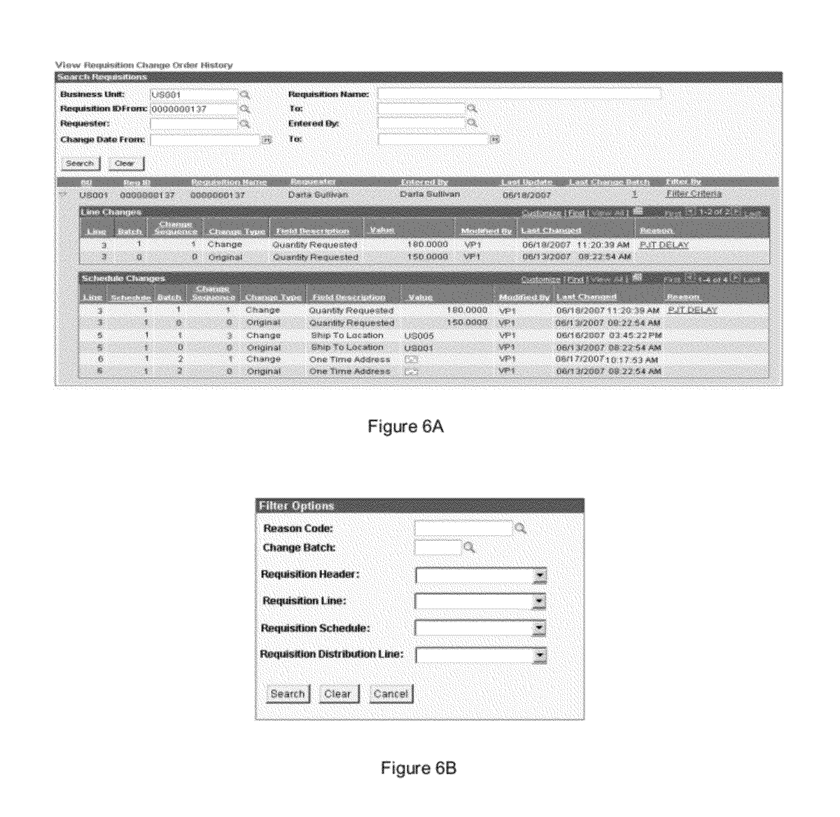

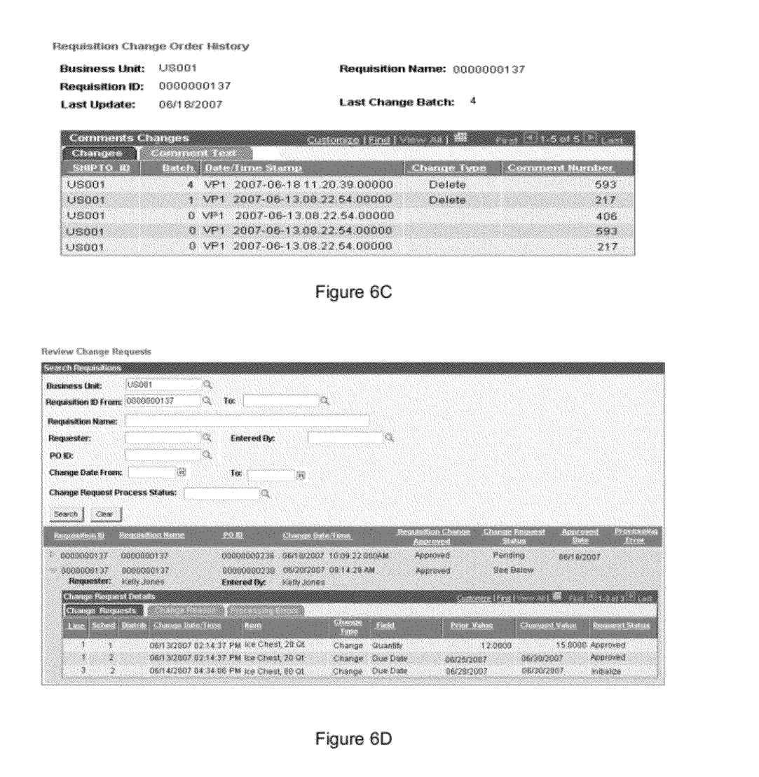

Referring next to FIGS. 6A-6D, which illustrate user interfaces for view and editing requisition change order histories, in accordance with aspects of the present invention. The user interface in FIG. 6A provides a view of requisition change history. The interface in FIG. 6B provides an interface for entering filtering criteria of requisition change histories. The filter criteria may be specified once the grid is expanded to display only particular changes. If the filter criteria link is selected, FIG. 6B may be brought up for users to specify filter criteria. Further, FIG. 6C shows a requisition change order history view, and FIG. 6D provides an interface for reviewing change order requests. For each change request, display header and detail information may be shown. Further, if approval status is the same for all change request lines, a value in PO change approved for the change may be displayed. The PO change approved value can be either pending, denied, or approved. Also, for the header level information, a ‘Y’ may be displayed in the processing error column, if any of the associated request details had processing errors, and error details may be viewed at the detail level (the PO Updated Value can be Pending, Complete, or Error).

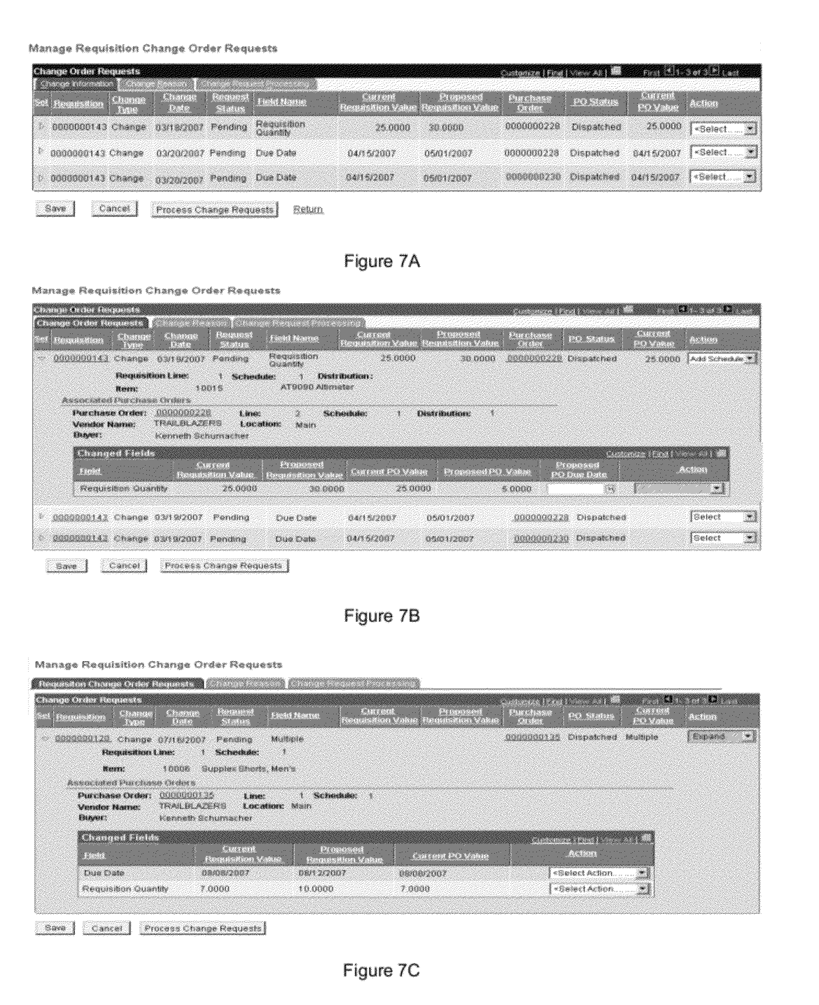

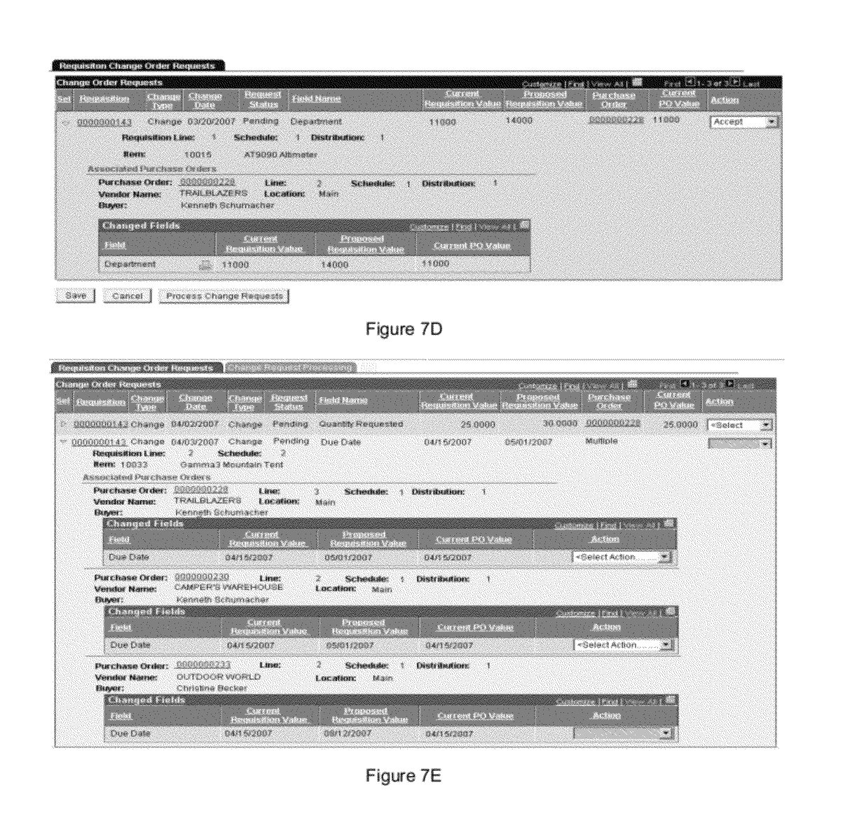

Referring now to FIGS. 7A-7E, which illustrate user interfaces for implementing a requisition change order request, in accordance with aspects of the present invention. The user interfaces in FIGS. 7A-7C provide an interface for managing requisition change order requests. When the worklist link is selected, one of FIGS. 7A-7C may be displayed to show the purchase orders associated to the changed requisition. Buyers can use this page to link to purchase orders and make changes there. The page is also available from a buyer center menu, and if accessed from the buyer center menu, the buyer can search for change requests. Search criteria may include: business unit, requisition ID, requisition name, requester, buyer ID, purchase order, and change request date. Buyers can also select change requests that have or have not been processed and those with processing errors. Alternatively, if accessed from the worklist, only changes associated to the requisition on the worklist may be shown. Change requests displayed would include those waiting to be accepted, those in process, and those that have been applied.

This interface may also be accessed from the approve change requests page. If buyers have used that option, they will be brought to the requisition change orders page with the requisitions meeting the select criteria displayed. Alternatively, if the page has been accessed from the approve change requests page, a link should be displayed at the bottom of the page to allow the buyer to return to the approve change requests page. The page should display only requisitions associated to purchase orders belonging to the buyer. The page should also show the requisition number, the change type, change field, current field value, proposed field value, and purchase order to which the requisition is associated. Further, if the requisition change is at the line level, when the requisition is unfolded the schedule and distribution columns may be blank, and if the requisition change is made at the schedule level, the distribution column may be blank.

Furthermore, reason codes and comments should be available on the change reason tab, and if the change request has already begun processing, the action box may be grayed out. The change request processing tab may include a column to indicate whether the change request has been accepted (values can be pending approval, approved, or denied). Another column will show process status for those changes that have been accepted. If the process status is “Error”, it will show the message set, message number, and long message description. If the Error is a budget checking error, then another column should be shown with the header budget status (otherwise this column may be hidden).

Additionally, this page can be accessed from a worklist or from a menu option. If the page is accessed from a menu, all requisition change requests would be displayed here, not just those for a specific requisition, as would be done if accessing via the worklist. The actions that can be taken on the requisition change requests page are included in Table 3:

TABLE 3

| Changed Requisition Field | Available Actions |
|---|---|
| Item Manufacturer | Accept Change |
| | Deny Change |
| Manufacturer Item Number | Accept Change |
| | Deny Change |
| Catalog | Accept Change |
| | Deny Change |
| Vendor Item | Accept Change |
| | Deny Change |
| Item Description | Accept Change |
| | Deny Change |
| Price | Accept Change |
| | Deny Change |
| UOM | Accept Change |
| | Deny Change |
| Item Category | Accept Change |
| | Deny Change |
| Requisition Quantity | Accept Change (Apply |
| | to existing schedule) |
| | Add a schedule |
| | Add a new PO |
| | Deny Change |
| Due Date | Accept Change |
| | Deny Change |
| Ship To | Accept Change |
| | Deny Change |
| Attention | Accept Change |
| | Deny Change |
| Distribution Quantity | Accept Change |
| | Deny Change |
| Accounting Information (Percent, | Accept Change |
| Location, Account, Alt Account, | Deny Change |
| Operating Unit, Fund, Department, | |
| Program, Class, Budget Reference, | |
| Program, Affiliate, Fund Affiliate, | |
| Operating Unit Affiliate, Budget Date, | |
| Statistics Code, Inventory Unit, PC | |
| Business Unit, Project, Activity, | |
| Source Type, Category, Subcategory, | |
| Asset Management Business Unit, | |
| Profile ID, Capitalized Flag, Cost | |
| Type, Speed Chart) | |
| Add a requisition Schedule | Accept Change |
| | Deny Change |
| Add a distribution line | Accept Change |
| | Deny Change |
| Cancel requisition line | Accept Change |
| | Deny Change |
| Cancel requisition schedule | Accept Change |
| | Deny Change |
| Multiple Changes | View Changes |
| Multiple Purchase Orders | Accept Change |
| | Deny Change |

Accept change if a single field is changed on a requisition sourced to a single PO, the buyer can approve the change request from this page. By selecting the accept change option from the drop down options, and pressing the save button, the approved flag PV_CHNG_REQST_DTL will be set to ‘Y’. This will enable the request to be picked up by the load change requests process, which will also mark the line as worked on the worklist.

Deny change is selected if the buyer denies the change request using the deny change request option. If this button is used: the buyer is prompted for a reason code and a comments box, an e-mail is returned to the requester with the requisition name, line, schedule, distribution, change field, prior value, new value, and reason code and description to let them know the change request is denied, the approved flag on PV_CHNG_RQST_DTL is set to denied, and the worklist entry is marked as worked.

Buyers can unfold to the purchase order to view and update the purchase order line associated to a requisition. If the change is a single field, other than quantity, on a single PO the unfolded PO information displays the purchase order line, schedule, and/or distribution line, depending on the level where the change is being made. The field to be changed, the existing value, and the new value are displayed, and the user may accept or deny the change. If the field changed is the one-time address, show all address fields for both the existing and new values.

If the field changed is a distribution chart field segment, show all chart field segments for both the existing and new requisition values and also for the existing PO Value. An icon displayed with the field may be selected to show all chart field segments. If multiple chart field segments were changed in a batch, display all changed segments at the top and display all the new chart field values in a single grid.

FIG. 7E includes an interface for changes to a schedule associated to multiple purchase orders. If the change is to a schedule that has been associated to more than one purchase order, the buyer will see “Multiple” listed in the purchase order column. When there are multiple PO's associated with a requisition schedule, the options available will be: accept change and deny change. When the buyer selects an action, the requisition will unfold and all purchase orders associated to the requisition are displayed. The buyer can then elect which purchase orders to which the change should be applied. When the accept (or deny) change button is selected, change rows should be added to the change request tables. If a requisition is tied to multiple PO's, but not all PO's are assigned to the current buyer, PO's belonging to other buyers will be displayed, but cannot be changed by the current buyer.

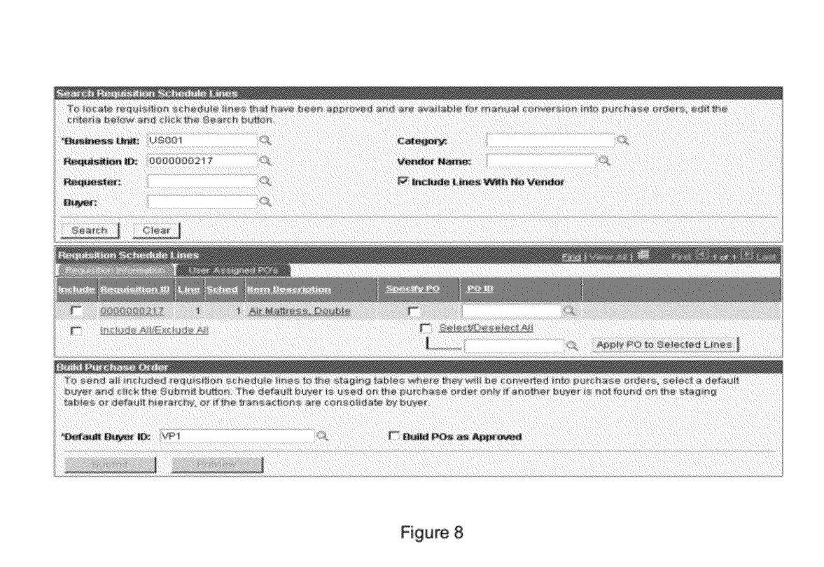

FIG. 8 illustrates a user interface for searching requisition schedule lines, in accordance with aspects of the present invention. The user interface provides users with the ability to select purchase orders when expediting requisitions. Users have the ability to add new requisition schedules to a specific purchase order. For example, users may wish to be able to include items related to a specific project to the same purchase order and they did not get all items included on the initial requisition. We will add the option to specify a purchase order in the requisition expedite process.

FIG. 8 further includes a tab on the Req Expedite page, where users can specify purchase orders to which a requisition schedule should be sourced. Users can update a single schedule at a time or can select multiple schedules to be included on the same PO. Further, when the staging records are created, the purchase order should be included in the PO_ITM_STG record.

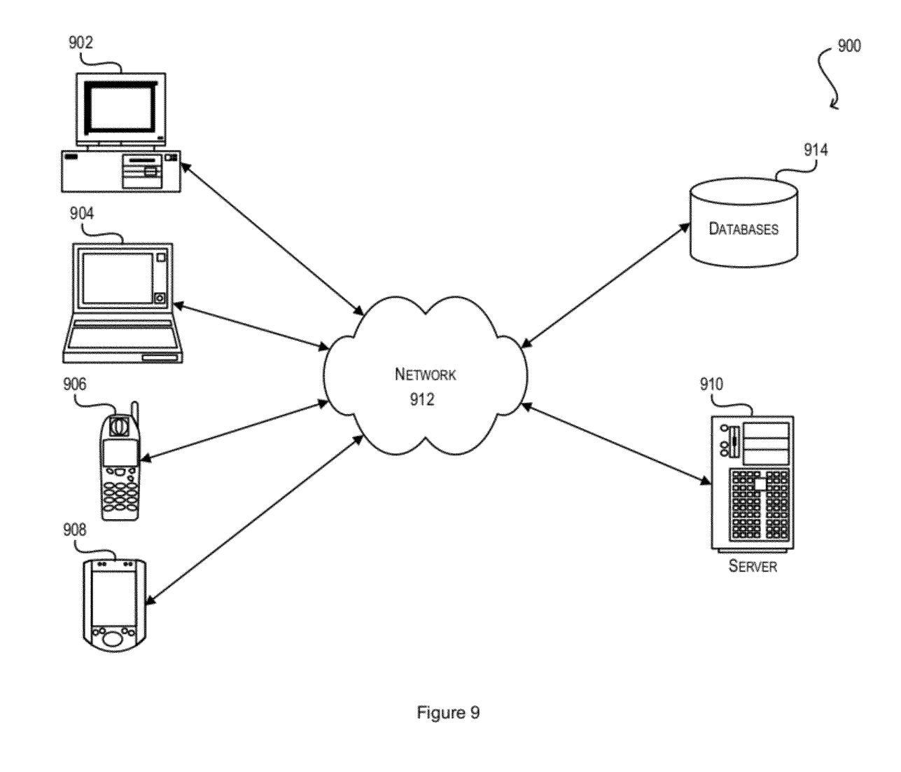

FIG. 9 is a simplified block diagram illustrating physical components of a system environment 900 that may be used in accordance with an embodiment of the present invention. This diagram is merely an example, which should not unduly limit the scope of the claims. One of ordinary skill in the art would recognize many variations, alternatives, and modifications.

As shown, system environment 900 includes one or more client computing devices 902, 904, 906, 908 communicatively coupled with a server computer 910 via a network 912. In one set of embodiments, client computing devices 902, 904, 906, 908 may be configured to run one or more components of a graphical user interface described above. For example, client computing devices allow user to create and customize network communities, enter search queries, view search results, and others.

Client computing devices 902, 904, 906, 908 may be general purpose personal computers (including, for example, personal computers and/or laptop computers running various versions of Microsoft Windows™ and/or Apple Macintosh™ operating systems), cell phones or PDAs (running software such as Microsoft Windows™ Mobile and being Internet, e-mail, SMS, Blackberry,™ and/or other communication protocol enabled), and/or workstation computers running any of a variety of commercially-available UNIX™ or UNIX™-like operating systems (including without limitation the variety of GNU/Linux™ operating systems). Alternatively, client computing devices 902, 904, 906, and 908 may be any other electronic device capable of communicating over a network (e.g., network 912 described below) with server computer 910. Although system environment 900 is shown with four client computing devices and one server computer, any number of client computing devices and server computers may be supported.

Server computer 910 may be a general purpose computer, specialized server computer (including, e.g., a LINUX™ server, UNIX™ server, mid-range server, mainframe computer, rack-mounted server, etc.), server farm, server cluster, or any other appropriate arrangement and/or combination. Server computer 910 may run an operating system including any of those discussed above, as well as any commercially available server operating system. Server computer 910 may also run any of a variety of server applications and/or mid-tier applications, including web servers, Java virtual machines, application servers, database servers, and the like. In various embodiments, server computer 910 is adapted to run one or more Web services or software applications described in the foregoing disclosure. For example, server computer 910 is specifically configured to implemented enterprise procurement systems described above.

As shown, client computing devices 902, 904, 906, 908 and server computer 910 are communicatively coupled via network 912. Network 912 may be any type of network that can support data communications using any of a variety of commercially-available protocols, including without limitation TCP/IP, SNA, IPX, AppleTalk™, and the like. Merely by way of example, network 912 may be a local area network (LAN), such as an Ethernet network, a Token-Ring network and/or the like; a wide-area network; a virtual network, including without limitation a virtual private network (VPN); the Internet; an intranet; an extranet; a public switched telephone network (PSTN); an infra-red network; a wireless network (e.g., a network operating under any of the IEEE 802.11 suite of protocols, the Bluetooth™ protocol known in the art, and/or any other wireless protocol); and/or any combination of these and/or other networks. In various embodiments, the client computing devices 902, 904, 906, 908 and server computer 910 are able to access the database 914 through the network 912. In certain embodiments, the client computing devices 902, 904, 906, 908 and server computer 910 each has its own database.

System environment 900 may also include one or more databases 914. Database 914 may correspond to an instance of integration repository as well as any other type of database or data storage component described in this disclosure. Database 914 may reside in a variety of locations. By way of example, database 914 may reside on a storage medium local to (and/or resident in) one or more of the computing devices 902, 904, 906, 908, or server computer 910. Alternatively, database 914 may be remote from any or all of the computing devices 902, 904, 906, 908, or server computer 910 and/or in communication (e.g., via network 912) with one or more of these. In one set of embodiments, database 914 may reside in a storage-area network (SAN) familiar to those skilled in the art. Similarly, any necessary files for performing the functions attributed to the computing devices 902, 904, 906, 908, or server computer 910 may be stored locally on the respective computer and/or remotely on database 914, as appropriate. For example the database 914 stores user profiles, procurement information, attributes associated with network entities.

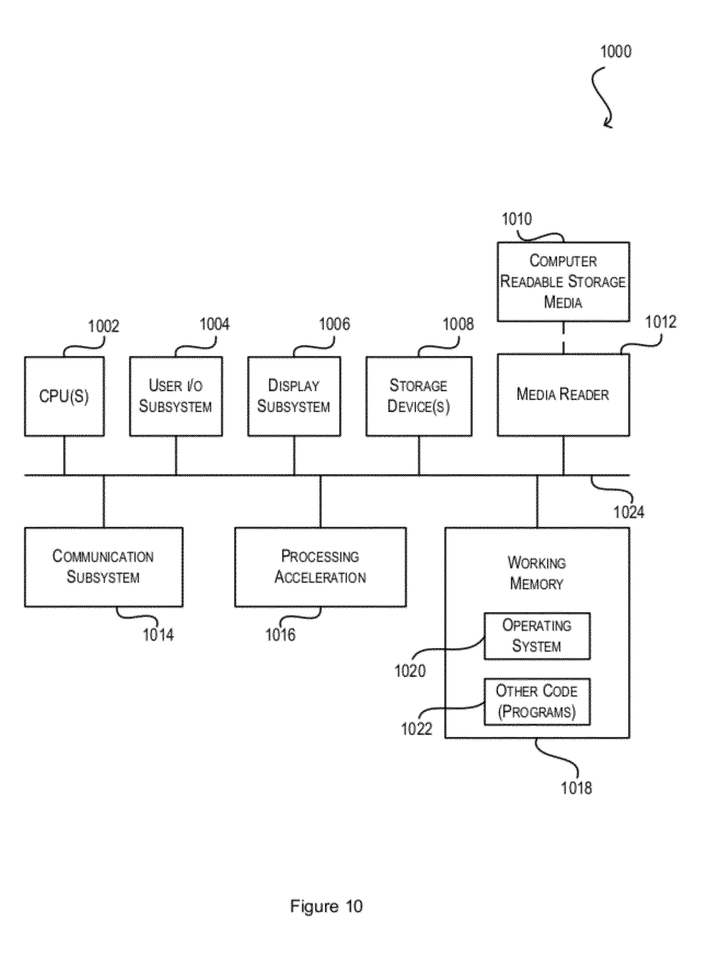

FIG. 10 is a simplified block diagram illustrating the physical components of a computer system 1000 that may be used in accordance with an embodiment of the present invention. This diagram is merely an example, which should not unduly limit the scope of the claims. One of ordinary skill in the art would recognize many variations, alternatives, and modifications.

In various embodiments, computer system 1000 may be used to implement any of the computing devices 902, 904, 906, 908, or server computer 910 illustrated in system environment 900 described above. As shown in FIG. 10, computer system 1000 comprises hardware elements that may be electrically coupled via a bus 1024. The hardware elements may include one or more central processing units (CPUs) 1002, one or more input devices 1004 (e.g., a mouse, a keyboard, etc.), and one or more output devices 1006 (e.g., a display device, a printer, etc.). For example, the input devices 1004 are used to receive user inputs for procurement related search queries. Computer system 1000 may also include one or more storage devices 1008. By way of example, storage devices 1008 may include devices such as disk drives, optical storage devices, and solid-state storage devices such as a random access memory (RAM) and/or a read-only memory (ROM), which can be programmable, flash-updateable and/or the like. In an embodiment, various databases are stored in the storage devices 1008. For example, the central processing units 1002 is configured to retrieve data from a database and process the data for displaying on a GUI.

Computer system 1000 may additionally include a computer-readable storage media reader 1012, a communications subsystem 1014 (e.g., a modem, a network card (wireless or wired), an infra-red communication device, etc.), and working memory 1018, which may include RAM and ROM devices as described above. In some embodiments, computer system 1000 may also include a processing acceleration unit 1016, which can include a digital signal processor (DSP), a special-purpose processor, and/or the like.

Computer-readable storage media reader 1012 can further be connected to a computer-readable storage medium 1010, together (and, optionally, in combination with storage devices 1008) comprehensively representing remote, local, fixed, and/or removable storage devices plus storage media for temporarily and/or more permanently containing computer-readable information. Communications system 1014 may permit data to be exchanged with network 912 of FIG. 9 and/or any other computer described above with respect to system environment 900.

Computer system 1000 may also comprise software elements, shown as being currently located within working memory 1018, including an operating system 1020 and/or other code 1022, such as an application program (which may be a client application, Web browser, mid-tier application, RDBMS, etc.). In a particular embodiment, working memory 1018 may include executable code and associated data structures for one or more of the design-time or runtime components/services illustrated in FIGS. 3 and 6. It should be appreciated that alternative embodiments of computer system 1000 may have numerous variations from that described above. For example, customized hardware might also be used and/or particular elements might be implemented in hardware, software (including portable software, such as applets), or both. Further, connection to other computing devices such as network input/output devices may be employed. In various embodiments, the behavior of the view functions described throughout the present application is implemented as software elements of the computer system 1000.

In one set of embodiments, the techniques described herein may be implemented as program code executable by a computer system (such as a computer system 1000) and may be stored on machine-readable media. Machine-readable media may include any appropriate media known or used in the art, including storage media and communication media, such as (but not limited to) volatile and non-volatile, removable and non-removable media implemented in any method or technology for storage and/or transmission of information such as machine-readable instructions, data structures, program modules, or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices, or any other medium which can be used to store or transmit the desired information and which can be accessed by a computer.

Although specific embodiments of the present invention have been described, various modifications, alterations, alternative constructions, and equivalents are within the scope of the invention. Further, while embodiments of the present invention have been described using a particular combination of hardware and software, it should be recognized that other combinations of hardware and software are also within the scope of the present invention. The present invention may be implemented only in hardware, or only in software, or using combinations thereof.

The specification and drawings are, accordingly, to be regarded in an illustrative rather than a restrictive sense. Many variations of the invention will become apparent to those skilled in the art upon review of the disclosure. The scope of the invention should, therefore, be determined not with reference to the above description, but instead should be determined with reference to the pending claims along with their full scope or equivalents.

What is claimed is:

1. A method of implementing a procurement change request process, the method comprising:
receiving a request to edit a requisition order from a requestor, wherein the requisition order has been previously completed and the requisition order includes a plurality of lines;
receiving updates to at least one of the plurality of lines of the requisition order;
based on the received updates, updating the at least one of the plurality of lines of the requisition order;
determining that the at least one of the plurality of lines has been sourced to a purchase order;
in response to the at least one of the plurality of lines being sourced to the purchase order, creating a requisition change request for the at least one of the plurality of lines; and
updating the purchase order with the updates to the at least one of the plurality of lines of the requisition order.

2. A method of implementing a procurement change request process as in claim 1, further comprising in response to the updating the at least one of the plurality of lines of the requisition order, creating a change tracking record.

3. A method of implementing a procurement change request process as in claim 1, further comprising determining that none of the plurality of lines of the requisition order have been sourced to the purchase order.

4. A method of implementing a procurement change request process as in claim 3, further comprising:
determining that the updates to the at least one of the plurality of lines have been approved; and
transmitting an updated purchase order to a buyer.

5. A method of implementing a procurement change request process as in claim 3, further comprising:
determining that the updates to the at least one of the plurality of lines have not been approved; and
notifying the requestor that the updates to the requisition order have not been approved.

6. A method of implementing a procurement change request process as in claim 5, wherein the notifying of the requestor comprised sending one of: an email, a short message service (SMS) text, or a telephone communication.

7. A method of implementing a procurement change request process as in claim 1, wherein the requisition order comprises a budget.

8. A method of implementing a procurement change request process as in claim 7, further comprising determining if the updates to the at least one of the plurality of lines of the requisition order invalidates the budget.

9. A method of implementing a procurement change request process as in claim 8, further comprising in response to determining that the budget is invalidated, notifying the requestor that the changes have not been entered due to an invalid budget.

10. A method of implementing a procurement change request process as in claim 8, further comprising:
determining that the budget is valid; and
determining if the updates change the source amount of the requisition order.

11. A method of implementing a procurement change request process as in claim 10, further comprising in response to determining that the updates change the source amount of the requisition order, performing a budget check on the purchase order.

12. A method of implementing a procurement change request process as in claim 10, further comprising in response to determining that the updates do not change the source amount of the requisition order, generating a purchase order change request.

13. A method of implementing a procurement change request process as in claim 12, further comprising:
processing the purchase order change request; and
determining if the purchase order change request generates process exceptions.

14. A method of implementing a procurement change request process as in claim 13, further comprising in response to determining that the purchase order change request does not generate process exceptions, updating the purchase order.

15. A method of implementing a procurement change request process as in claim 13, further comprising:
in response to determining that the purchase order change request generates process exceptions, undoing the changes to the purchase order; and
notifying the requestor that the changes to the purchase order have been undone.

16. A method of implementing a procurement change request process as in claim 1, further comprising:
generating a purchase order change request;
determining that the purchase order's budget is valid; and
in response to the determination that the purchase order's budget is invalid, notifying the purchase order's buyer that the purchase order's budget is invalid.

17. A non-transitory computer-readable storage medium, having sets of instructions stored thereon which, when executed by a computer, cause the computer to:
receive a request to edit a requisition order from a requestor, wherein the requisition order has been previously completed and the requisition order includes a plurality of lines;
receive updates to at least one of the plurality of lines of the requisition order;
based on the received updates, update the at least one of the plurality of lines of the requisition order;
determine that the at least one of the plurality of lines has been sourced to a purchase order;
in response to the at least one of the plurality of lines being sourced to the purchase order, create a requisition change request for the at least one of the plurality of lines; and
update the purchase order with the updates to the at least one of the plurality of lines of the requisition order.

18. A non-transitory computer-readable medium as in claim 17, wherein the sets of instructions when further executed by the computer, cause the computer to determine that none of the plurality of lines of the requisition order have been sourced to the purchase order.

19. A non-transitory computer-readable medium as in claim 17, wherein the sets of instructions when further executed by the computer to:
determine that the updates to the at least one of the plurality of lines have been approved; and
transmit an updated purchase order to a buyer.

20. A method of implementing a procurement change request process, the method comprising:
receiving a request to edit a requisition order from a requestor, wherein the requisition order has been previously completed and the requisition order includes a plurality of lines and a budget;
receiving updates to at least one of the plurality of lines of the requisition order;
based on the received updates, updating the at least one of the plurality of lines of the requisition order;
determining that the at least one of the plurality of lines has been sourced to a purchase order;
in response to the at least one of the plurality of lines being sourced to the purchase order, creating a requisition change request for the at least one of the plurality of lines;
based on the requisition change request, checking the budget to determine if the budget is valid and checking if the requisition change request generates a process exception for the requisition order;
in response to the budget being valid and no process exceptions being generated, updating the purchase order with the updates to the at least one of the plurality of lines of the requisition order.
